(19) United States
(12) Patent Application Publication
(10) Pub. No.: US 2014/0306786 A1
(43) Pub. Date: Oct. 16, 2014

(54) CURRENT TRANSFORMER

(71) Applicant: AREVA T&D INDIA LTD., Noida (IN)

(72) Inventors: Mohan SRINIVASRAO, Bangalore (IN); Zoltan ROMAN, Grovetown, GA (US)

(21) Appl. No.: 13/945,301

(22) Filed: Jul. 18, 2013

Related U.S. Application Data
(63) Continuation of application No. PCT/IN2009/000431, filed on Jul. 28, 2009.

(30) Foreign Application Priority Data
Nov. 27, 2008 (IN) 2690/DEL/2008

(51) Int. Cl. H01F 27/32; H01F 27/02

(52) U.S. Cl. CPC H01F 27/324; H01F 27/02
USPC 336/94

(57) ABSTRACT

A current transformer (5) having a plurality of primary and secondary windings, comprising a top housing head (10), a column (20) of insulating material mounted on a base (30) which supports said top housing head, a guide tube passing through a central passage in said column, a metal core casing (40), inside said top housing head, enclosing a plurality of cores (42) along with secondary windings, wherein said top housing head is a non metallic tank which supports a primary conductor (18) having bushing insulation layers (34) thereon and a dielectric fluid (8) fills said top housing head and said column of insulating material.

### FIELD OF INVENTION

The present invention relates in general to electric inductive apparatus, such as transformers, and more specifically to new and improved current transformers.

### BACKGROUND OF THE INVENTION

Current transformers are commonly used in metering and protective relaying in power industry where they facilitate safe measurement of large currents, often in the presence of high voltages. The rapid growth and high demand in the power generation, transmission and distribution systems impels all manufacturing utilities to design compact, optimal and cost-efficient power equipment like current transformers.

Generally, a current transformer of top core design is formed by a top metallic housing supported by a hollow tubular insulated column, which is preferably fixed on a grounded base. Secondary windings are enclosed in a metallic core casing, which in turn is connected to the ground through metal tube passing centrally through the hollow insulator. Either the metallic core housing or primary conductor is insulated for the voltage class.

A high voltage current transformer of top core design is described in U.S. Pat. No. 4,117,437. This current transformer is formed by a column of insulating material supporting a metal housing. Through the said column a primary conductor passes and a grounded metal casing encloses a plurality of cores with secondary windings. In the top part of the transformer insulated metal rings are provided for uniform voltage distribution in the annular regions between the core casing and the metal housing. However, the known art does not effectively reduce weight of a transformer due to the use of insulation materials provided onto the passage in the insulating column and use of top metallic housing head of the transformer tank. Further, the rectangular shape of core box and rectangular head housing creates very high stresses on the insulation materials thereby limiting the applicability of the transformer at high voltages.

In existing oil-filled insulated high voltage current transformer designs, insulation is applied on and around the parts that are on low-voltage. Because of the complex shape of the low-voltage parts the application of the insulating material is difficult. This might lead to weak points where severe mechanical/electrical stresses causes packaging and wedges to be loosened and finally shaken out, thereby resulting in electrical discharge or failure in the insulation. Also because of the complex shape, the insulating material needs to be flexible and therefore, only paper can be used as an insulator. The application of the insulation is labor intensive and requires skilled operators. The secondary winding(s) of the current transformers are inside the low-voltage parts whereas the primary winding of the current transformers are connected to high-voltage. The secondary windings have many variations, as opposed to the primary winding that is standardized with few variations. The application of insulation cannot precede the assembly of the secondary windings in the work-flow. The dynamic pressure from Market on prices and consequently on the cost have made the existing product not so effective due to material and labour cost as well as human dependent production process.

Moreover, the known current transformers are always prone to internal faults like failure of complex-shaped insulations. Further the high current produces severe mechanical stresses on the internal components specially the insulation and transformer windings. These stresses developed on the metallic housing both by external and internal faults severely affect the safety and reliability of the known current transformers.

Thus, the principal object of the invention is to optimize the size and weight of the current transformer so as to minimize the stresses developed leading to substantial improvement in quality of the current transformer.

A further object of the present invention is to minimize the usage of insulation materials thereby reducing the cost of manufacturing of the current transformer which would meet the high demand of current transformers in the power industry.

A still further object of the present invention is to ease the manufacturability of the present invention by introducing novel and inventive features resulting in less labor cost and material costs.

### SUMMARY OF THE INVENTION

Accordingly the present invention provides a current transformer having a plurality of primary and secondary windings, comprising: a top housing head, a column of insulating material mounted on a base which supports said top housing head, a guide tube passing through a central passage in said column; a metal core casing, inside said top housing head, enclosing a plurality of cores along with secondary windings; wherein said top housing head is a non metallic tank which supports a primary conductor having bushing insulation layers thereon and in that a dielectric fluid fills said top housing head and said column of insulating material and said base having a compensating device for allowing oil expansion and contraction.

### BRIEF DESCRIPTION OF THE DRAWINGS

The invention may be better understood and further advantages and uses thereof more readily apparent, when considered in view of the following detailed description of exemplary embodiments, taken with the accompanying drawings in which:

FIG. 1 illustrates a current transformer constructed according to the teachings of the present invention where the head portion is shown with its internal components.

FIG. 2 is side view of said current transformer according to one embodiment of the present invention.

### DESCRIPTION OF THE PREFERRED EMBODIMENTS

The present invention is described hereinafter by various embodiments with reference to the accompanying drawings, wherein reference numerals used in the accompanying drawings correspond to the like elements throughout the description. In order to achieve full description and explanation, specific details have been mentioned to provide a thorough and comprehensive understanding of various embodiments of the present invention. However, said embodiments may be utilized without such specific details and in various other ways broadly covered herein.

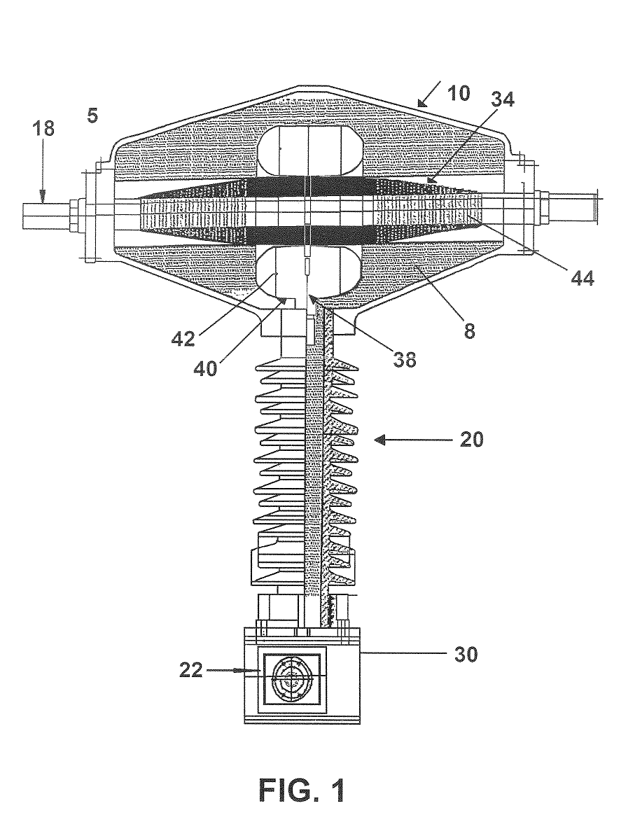

FIG. 1 illustrates a current transformer 5 comprising a top housing head 10 which is a non-metallic tank enclosing a plurality of primary and secondary windings and a conductor-bushing unit.

The top housing head 10 is supported on a column 20 of insulating material which is mounted on a base 30. The top housing head 10 is preferably made up of epoxy/FRP/Glass/Porcelain and forms a chamber for a dielectric fluid 8 which may be liquid or gas such as mineral oil/synthetic/vegetable oil or insulating gas, for example sulphur hexafluoride (SF₆) or equivalent. The use of insulation medium like epoxy for the non metallic housing head 10 not only results in the reduction in weight of the top head portion of the current transformer but it also obviates the usage of other insulating materials for low voltage parts of the current transformer. The conductor-bushing unit is a high voltage unit comprising a tubular bushing 34 and a primary conductor 18 of single bar type (double/triple ratio). According to another aspect of the invention, the primary conductor is of wound type. The primary conductor is insulated in the form of a hollow cylinder constructed as a capacitor bushing for reducing the electric field stresses wherein said capacitor bushing forms low value capacitor between said conductor and housing wall. According to another embodiment of the present invention, said primary conductor is insulated in the form of a solid cylinder. FIG. 1 clearly illustrates the primary conductor 18 having primary windings 44 and extends out of the top housing head 10 forming the primary terminals.

A metallic case 40 houses winded magnetic cores 42 which are placed in the middle of the insulated primary conductor 18. The metallic case 40 is connected to the base 30 through a metallic guide tube 38 which passes though the centre of hollow insulator 20. According to one embodiment of the present invention, the primary conductor 18 is made of conductive material. According to another embodiment of the present invention said primary conductor 18 is made of a fibrous material coated with a conductive material.

In a different embodiment of the present invention, insulation may be provided on the high-voltage part either directly to the bar 18 or to a conduit made up of a conductive material or fibrous material coated with a conductive material. The bushing insulation layers 34 provided on the primary conductor varies with the width of the bushing decreasing from inside outwardly. The secondary cores 42 together with the windings are suitably placed inside a metallic ease 40 which is connected to the guide tube 38. The metallic case 40 is completely enclosed inside said top housing head 10.

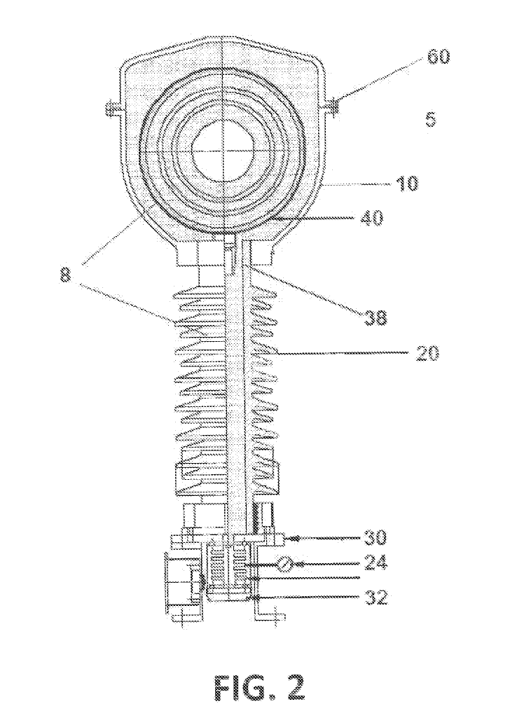

FIG. 2 illustrates a side view of the current transformer. A tubular column 20 of insulating material is mounted on a base 30 and supports said top housing head 10. The tubular column 20 is made up of insulating material which is preferably porcelain/polymer and includes a guide tube 38 containing the terminal members for the conductors from the secondary windings at the top of the transformer 5. The secondary leads are taken through said guide tube 38 to the terminal box 22 as shown in FIG. 1 at the base 30. The tubular column 20 is filled with dielectric fluid 8 which substantially surrounds the guide tube 38. The guide tube 38 as such is not provided with any insulation and this considerably reduces the use of insulating materials to be used in the manufacturing of current transformer as disclosed in the embodiments of the present invention.

According to another embodiment, the base 30 supports the lower portion of the tubular column of the hollow insulator 20. The base 30 comprises of a grounded box made of C channels fixed to a rectangular plate and has a compensating device 32 for allowing the oil expansion and contraction depending on the oil temperature variations. The terminal box 22 as shown in FIG. 1, is embedded in one of said C channels of the base and gives way for the secondary leads. A pressure gauze 24 is fixed to the compensating device 32 for constantly measuring the oil level in the current transformer 5. The bottom of the base 30 is provided with oil tight sealing to avoid oil losses. Oil tight sealing 60 is also provided to the top head housing for preventing any fluid losses. According to another embodiment, compensating device 32 is located at the top housing head 10.

Advantageously, the usage of the dielectric fluid 8 inside the top housing head 10 and the hollow insulated column 20 substantially brings down the cost of manufacturing of the current transformer due to reduction of insulation materials usage. Accordingly, the diameter of said tubular hollow insulator made of porcelain preferably, is reduced. The non-metallic top head housing 10 further results in reduced porcelain creepage. Furthermore, there is overall reduction in size and weight of the current transformer as disclosed in the embodiments of the present invention. The reduced weight of the top portion and the stein portion of the current transformer eases manufacturability and optimization of the base 30 of the current transformer 5 disclosed in the embodiments of the present invention.

Still further embodiment of the present invention enables the current transformer structure to provide for multiple primary turns, thereby, providing for a broader application range.

The top housing head 10 incorporates a preferably rounded core box including metal casing 40 to reduce the stresses developed in the insulation materials in the current transformer. The rounded shape of the core box and the head housing is clearly illustrated in FIG. 2 which again broadens the applicability of current transformer of the present invention at higher voltages. The designed stress levels of bushing for a 145 kV primary insulation design are as follows:

Radial stress at rated phase voltage—27.7 kV/cm

Radial Stress at power frequency phase voltage—90.8 kV/cm

Axial Stress at power frequency phase voltage—10.18 kV/cm

Radial Stress at impulse phase voltage—214.7 kV/cm

Axial Stress at impulse phase voltage—24.01 kV/cm

From the preceding description of the preferred embodiments it is evident that the object of the present invention arc attained and although the invention has been described and illustrated in detail, it is to be clearly understood that the same is by way of illustration and example only and is not to be taken by way of limitation.

1. A current transformer having a plurality of primary and secondary windings, comprising:
a top housing head;
a column of insulating material mounted on a base which supports said top housing head;
a guide tube passing through a central passage in said column;
a metal core casing, inside said top housing head, enclosing a plurality of cores along with secondary windings;
wherein said top housing head is a non metallic tank which supports a primary conductor having bushing insulation layers thereon and in that a dielectric fluid fills said top housing head and said column of insulating material.

2. A current transformer as claimed in claim 1, wherein said primary conductor is a hollow cylinder or solid conductor constructed as a capacitor bushing.

3. A current transformer as claimed in claim 2, wherein said hollow cylinder is made of conductive material.

4. A current transformer as claimed in claim 2, wherein said hollow cylinder is coated with a conductive material.

5. A current transformer as claimed in claim 1, wherein said primary conductor is of bar type.

6. A current transformer as claimed in claim 1, wherein said primary conductor is of wound type.

7. A current transformer as claimed in claim 1, wherein the width of said bushing insulation layers decreases from inside outwardly.

8. A current transformer as claimed in claim 1, wherein said column of insulating material is an elongated tubular hollow column.

9. A current transformer as claimed in claim 1, wherein said metal core casing is fixed to said guide tube forming a passageway for secondary leads.

10. A current transformer as claimed in claim 1, wherein said base is a grounded box made of C channels fixed to a rectangular plate and having terminal members for the conductors from the windings.

11. A current transformer as claimed in claim 1, wherein said base has a secondary terminal box which is embedded on one of said C channels.

12. A current transformer as claimed in claim 1, wherein said base comprises a compensating device for allowing oil expansion and contraction.

13. A current transformer as claimed in claim 1, wherein said plurality of cores are magnetic cores.

14. (canceled)
